(19) United States
(12) Patent Application Publication
(10) Pub. No.: US 2009/0118865 A1
(43) Pub. Date: May 7, 2009

(54) ROBOT

(75) Inventors: Saku EGAWA, Toride (JP); Ryosuke NAKAMURA, Hitachinaka (JP); Azusa AMINO, Hitachinaka (JP); Junichi TAMAMOTO, Kasumigaura (JP); Manabu YANAGIMOTO, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/264,958

(22) Filed: Nov. 5, 2008

(30) Foreign Application Priority Data
Nov. 5, 2007 (JP) 2007-286866

(51) Int. Cl. B25J 19/04

(52) U.S. Cl. 700/259; 901/47

(57) ABSTRACT

Described herein is a robot having a camera mount that is movable along a curved surface of an upper part of the head, on a front side thereof, and two units of cameras that are mounted in the camera mount. The cameras are disposed such that the cameras are laterally separated from each other at an interval substantially equivalent to a lateral width of the head, respective extremities of the cameras are substantially flush with the front end of the head, and the cameras are positioned in close proximity of the upper end of the robot.

### BACKGROUND OF THE INVENTION

1. Field of the Invention

The invention relates to a robot, and in particular, to a robot with a camera mounted therein.

2. Description of the Related Art

There have since been developed a robot capable of traveling among human beings at home, in the office, and in public space, and so forth to provide various services such as transportation of objects, and so forth. The robot is mostly provided with a camera, a sensor, and so forth, mounted in an upper part of a main body thereof, for collection of information, and in the case of an anthropomorphic robot, the camera, sensor, and so forth are mostly mounted in the head of the robot.

It has been well known that the robot is provided with a mechanism for moving the head with a camera mounted therein, in whole, or the camera mounted in the head, in order to widen an image-pickup range of the camera mounted in the robot.

In Patent document 1, there has been disclosed the head of a robot, wherein a second stand rotatively reciprocating around a horizontal axis is joined with a first stand while vision-sensing means are fitted to the second stand, and the head covering the first and second stands, including drive means, and the vision-sensing means, in whole, are joined with a stay effectively integral with the second stand, thereby causing the vision-sensing means to be operated integrally with the head.

Further, in Patent document 2, there has been disclosed a robot having the neck for linking the head with the trunk of the robot in a rotatively reciprocating manner, the neck having a first rotational shaft rotatively reciprocating in a roll-axis direction, a second rotational shaft rotatively reciprocating in a pitch-axis direction, a third rotational shaft rotatively reciprocating in a yaw-axis direction, and a fourth rotational shaft rotatively reciprocating in the pitch-axis direction.

[Patent document 1] JP-A No. 2002-154084

[Patent document 2] JP-A No. 2003-300366

A robot operating among human beings is preferably of a minimum size to enable a necessary work to be executed on the grounds of not interfering with the human beings, and for safety reasons. Meanwhile, the robot is required to execute operations against furniture manufactured to a size matching human beings. For example, in the case of the robot executing an operation for placing an object on a desk, the robot has to check a state of the top of the desk provided with a top board having a height matching the human beings by use of a sensor such as a camera and so forth, before extending a manipulator (a hand) over the desk to thereby place the object thereon.

Accordingly, specific features are required of a sensor, such as an image pickup device, in order to accomplish an anthropomorphic robot, in particular. For example, when an operation is executed with a robot small in size, as shown in FIG. 5, a robot 1 is relatively short in height in relation to a desk 63, so that there is the need for a sensor having a visual field 71 oriented in a horizontal direction from the highest spot of the robot in order to observe a target object 60 placed on the desk 63 with the use of a camera. Furthermore, in the case of the robot checking a state of a region of a floor surface 66, immediately ahead of the robot, when the robot travels, and in the case of the robot grasping an object placed at a low position before transportation, there is the need for a visual field 72 oriented in a direction directly below.

In the case where cameras are installed in the head of a robot, corresponding to the head of a human being, there arises the need for a drive mechanism for changing orientation of the cameras up and down in order to observe a state of the surroundings, in a range as wide as above-described. A human being is capable of looking in a direction to be watched not only by changing its posture to thereby move the head thereof, but also by moving a multitude of movable parts as necessary, however, in order to cause the anthropomorphic robot to carry out similar actions, there will be the needs for complex control while keeping the robot in balance as well as a sufficient number of movable parts.

In this connection, with the drive mechanism for changing the orientation of the cameras up and down, there are requirements for easiness in keeping the robot in balance, and compactness of the robot in order to prevent the robot from coming into contact with the surroundings during operation, in addition to capability of observing the state of the surroundings, in the range as wide as above-described. Further, at the same time, the robot is also required not to impair an affinity with the human beings.

Conventional technologies described as above have had difficulties in meeting those requirements. With the conventional technologies, the camera are at a low position all the time, so that it has been difficult for the robot to see a high position as seen from the robot, such as the top of the desk.

With a technology described in Patent document 1, the head of the robot, in whole, is moved, however, there is a limitation to a movable range of the robot, in a downward direction, because a lower part of the head comes into contact with the neck of the robot, so that it has been difficult to sufficiently obtain the visual field oriented in the direction directly below. Further, with a technology described in Patent document 2, the head in whole travels forward when the robot looks in a downward direction, so that it has been difficult for the robot to keep itself in balance.

### SUMMARY OF THE INVENTION

It is therefore an object of the invention to provide a robot wherein a capable, compact, and movable image pickup device is installed in the head of the robot in order to ensure execution of traveling, and operation with reliability.

In order to address the problems described as above, a robot according to one aspect of the invention includes a main body, a head installed above the main body, a camera mount installed so as to be movable along a curved surface of an upper part of the head, on a front side thereof, and cameras mounted in the camera mount.

With the aspect of the invention, it is possible to observe a wide range from a visual field in a high position to a visual field oriented in a direction directly below, and operations for traveling and transportation of objects can be safely executed with reliability.

### BRIEF DESCRIPTION OF THE DRAWINGS

Embodiment(s) of the present invention will be described in detail based on the following figures, wherein:

FIG. 1 is a perspective view of a robot according to one embodiment of the invention;

FIG. 2 is a front view of the robot shown in FIG. 1;

FIG. 3 is a side view of the robot in FIG. 1;

FIG. 4 is a perspective view showing a drive mechanism for driving the head of the robot according to the present embodiment, and a camera mount thereof;

FIG. 5 is a perspective view for illustrating a visual field of the robot;

FIGS. 6A to 6C each are a side view showing respective actions of the head of the robot according to the present embodiment, and cameras thereof by way of example; and

FIG. 7 is a side view showing applications of the robot according to the present embodiment by way of example.

### DETAILED DESCRIPTION OF THE PREFERRED EMBODIMENTS

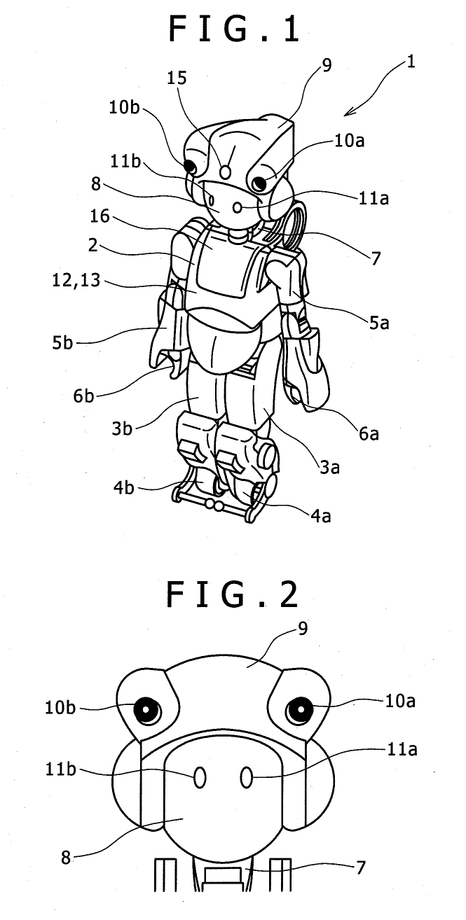

FIG. 1 shows an external view of a robot according to one embodiment of the invention. In this connection, a humanoid robot is described hereinafter as a robot according to the present embodiment of the invention by way of example, however, it is to be pointed out that the invention is not limited thereto. Further, a camera is described hereinafter as a movable image pickup device according to the present embodiment of the invention by way of example, however, it is to be pointed out that the invention is not limited thereto.

A robot 1 includes a trunk 2 as a main body, leg mechanisms 3a, 3b for causing the robot to travel, provided in a lower part of the trunk 2, and arms 5a, 5b, attached to upper parts of the trunk 2, respectively. Wheels 4a, 4b are installed at respective extremities of the leg mechanisms 3a, 3b. Further, hands 6a, 6b are installed at respective extremities of the arms 5a, 5b. A battery 12 for driving the robot 1, and a controller 13 are mounted in the trunk 2.

A neck 7 covering an internal frame thereof with a lid is installed at the upper part of the trunk 2. A head 8 is attached to the top of the neck 7 in such a way as to permit the head 8 to rotatively reciprocate against the trunk 2. In description given hereunder, a primary traveling direction of the robot 1 is referred to as a forward direction, and a direction opposite from the forward direction is referred to as a backward direction while a right side direction of the robot 1, facing the forward direction, as seen from the robot 1, is referred to as a right direction, and a left side direction of the robot 1, facing the forward direction, as seen from the robot 1, is referred to as a left direction.

Herein, the head 8 is generally a portion of the robot 1, installed on the top of the trunk 2 of the robot 1, having two features as follows. First, a sensor such as an image pickup device including cameras is mounted in the head 8. Since the head 8 is positioned at the uppermost part of the robot, and is able to acquire a wide visual field, the head 8 is suitable for use as a place where the cameras are mounted.

Further, the head 8 is imparted an external appearance whereby the head of a human being, or an animal can be visualized. This is useful for the purpose of facilitating transmission of information between human beings in the surroundings, and the robot. Accordingly, the front of the head 8, in particular, is mostly provided with a design for causing visualization of the eyes of a human being, or an animal. In this connection, in order to cause the visualization of the eyes, a design for causing visualization of two eyes in bilateral symmetry is provided in the vicinity of the center of the front of the head 8, or a design having goggles or a visor, and so forth, is provided so as to cause visualization of the eyes existing therein. With the present embodiment of the invention, a design on eyes 11a, 11b is provided at the front of the head 8. The cameras described as above are provided at either the same spot where the design on the eyes is provided, or a spot differing therefrom.

With the robot 1 according to the present embodiment of the invention, a camera mount 9 movable in relation to the head 8 is installed over the head 8. Two units of cameras 10a, 10b are mounted in the camera mount 9.

The camera mount 9 is designed so as to look like a cap placed on the head. In this case, the cameras 10a, 10b each are an electronic camera such as a CCD camera, CMOS camera, the two units of the cameras making up a stereo-camera for acquiring stereoscopic information. For speech dialogue, a speaker 16 is mounted in the trunk 2, and a microphone 15 is mounted in the camera mount 9.

The robot 1 is under autonomous control by the controller 13, traveling by use of the leg mechanisms 3a, 3b, and the wheels 4a, 4b. At the time of traveling, the controller 13 acquires stereoscopic images of the surroundings, and a floor surface, respectively, with the use of the cameras 10a, 10b, conducting recognition of a position of the robot 1 itself, and detection of obstacles, to thereby plan for, and control a path of traveling.

Further, the robot 1 executes operations for grasping and transporting an object such as, for example, a bottle, can, pet bottle, by use of the arms 5a, 5b, and the hands 6a, 6b, to thereby place it at a predetermined location such as on the top of a desk. At the time of the operations, the controller 13 acquires a stereoscopic image of a target object for each of the operations by use of the cameras 10a, 10b, conducting recognition of a shape as well as a position of the target object, to thereby plan for, and control actions of the arms 5a, 5b, respectively.

FIG. 2 is a front view of the robot 1 according to the present embodiment. The cameras 10a, 10b are disposed in bilateral symmetry at an interval substantially equivalent to a width of the head 8.

FIG. 3 is a side view of the robot 1 according to the present embodiment. In the figure, the design on the eyes 11a, 11b, provided in the head 8, and the cameras 10a, 10b are oriented in the horizontal direction, as is the case with FIG. 2, showing a state of a standard posture of the robot 1.

With the robot 1 in the state of the standard posture, the cameras 10a, 10b are disposed at a position higher than the design on the eyes 11a, 11b. Further, the cameras 10a, 10b are disposed at a height close of the upper end of the head 8 so as to be at the highest position of the robot 1. Furthermore, respective front ends of the cameras 10a, 10b are disposed so as to be substantially flush with the front end of the head 8 in the direction of a back-and-forth motion of the robot.

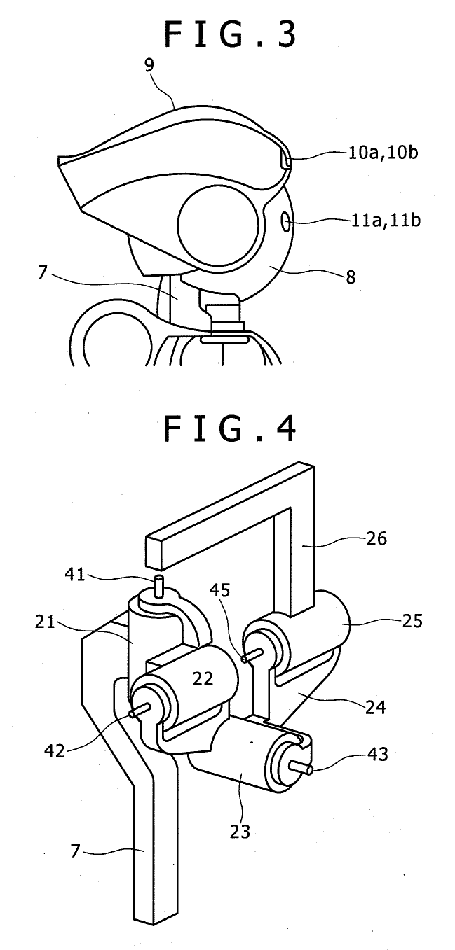

FIG. 4 is a view showing a structure of a drive mechanism for driving the head 8, and the camera mount 9, incorporated in the head 8. FIG. 4 is a layout sketch of the mechanism in the standard posture where the head 8, and the camera mount 9 are faced with the front side of the robot 1, in the horizontal direction.

A neck yaw-axis motor 21 with a rotational shaft 41 oriented in the vertical direction, a neck pitch-axis motor 22 with a rotational shaft 42 oriented in the lateral and horizontal direction, in the standard posture, and a neck roll-axis motor 23 with a rotational shaft 43 oriented in the back-and-forth and horizontal direction, in the standard posture, are mounted so as to be connected with each other in series within the neck 7 installed in the upper part of the trunk 2, frame-like in shape.

The rotational shaft 43 of the neck roll-axis motor 23 is linked with a head base 24, and the head 8 is linked with the head base 24. By driving the neck yaw-axis motor 21, the head 8 is caused to swing laterally, thereby executing an oscillating motion. By driving the neck pitch-axis motor 22, the head 8 is caused to swing vertically, thereby executing a motion such as giving a nod or looking up. By driving the neck roll-axis motor 23, the head 8 is caused to tilt laterally, thereby executing a motion for tilting the neck a little on one side.

The head base 24 has a rotational shaft 45 horizontally oriented in the standard posture, and the rotational shaft 45 is driven by a camera drive motor 25. A linkage member 26 is linked with the camera drive motor 25. The linkage member 26 is linked with the camera mount 9. The linkage member 26 and the camera drive motor 25, together with the center of a rotation for causing the camera mount 9 to moves along a curve in an upper part of the front of the head. 8, make up a turning radius.

The rotational shaft 45 is installed at a position where the rotational shaft 45 is rendered substantially coaxial with the rotational shaft 42 of the neck pitch-axis motor 22, in the standard posture shown in FIG. 4. Since the camera drive motor 25 is installed in the head base 24, the camera drive motor 25 is caused to move relatively against the head 8.

The rotational shaft 45 is installed so as to pass through a curved surface on the outer periphery of the head 8, and in particular, to pass a point in the vicinity of the center of curvature of the curved surface in the upper part of the front of the head 8. Further, the linkage member 26, the camera mount 9, and the cameras 10a, 10b are disposed such that a distance from the rotational shaft 45 to the camera 10a, or the camera 10b is greater than, or substantially equal to a distance from the rotational shaft 45 to the outer periphery of the head 8, in a section passing the camera 10a, or the camera 10b, and perpendicular to the rotational shaft 45, that is, in a section along a plane vertical and extending in the back-and-forth direction of the robot 1. By so doing, the cameras 10a, 10b are brought into intimate contact with, or into close proximity of the outer side of the head 8, thereby slidably moving thereon.

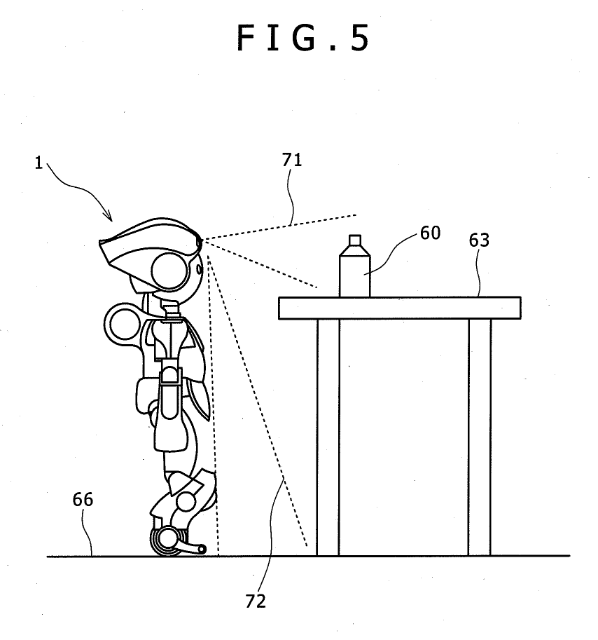

There is described thereinafter an action of the drive mechanism for driving the cameras of the robot 1 according the present embodiment. FIG. 5 is a view for illustrating an action of the head 8 of the robot 1 according the present embodiment, and the camera mount 9 with the cameras 10a, 10b, installed therein, respectively. In this case, it is assumed that the neck pitch-axis motor 22 and the neck roll-axis motor 23, mounted in the neck 7, are kept in the state of the standard posture, thereby moving the neck pitch-axis motor 22 and the camera drive motor 25.

In the state of the standard posture, respective positioning of the neck pitch-axis motor 22 and the camera drive motor 25 is kept such that the head 8 and the cameras 10a, 10b are each oriented in the horizontal direction. By moving the neck pitch-axis motor 22, and the camera drive motor 25 from the state as described, it is possible to move the head 8, and the camera mount 9 independently from each other, and continuously.

When the head 8 is moved downward, a movable range of the neck pitch-axis motor 22 is limited due to interference occurring between a lower end of the head 8, and the neck 7. Further, if the head 8 is moved upward to a large extent, this will cause a problem in that a gap is created between the trunk 2, and the head 8, thereby causing the interior of the head 8 to be exposed. There is available a method whereby a mechanism such as a shutter is used in order to conceal the gap, however, since the front of the head, in particular, has a function for causing the human beings in the surroundings to perceive the same as a face of a living being, it is undesirable to install a mechanism unseemly to the living being.

For this reason, there is difficulty in expanding the movable range. Accordingly, a motion of the head 8, by the neck pitch-axis motor 22, is combined with a motion of the camera mount 9, by the camera drive motor 25, thereby expanding a movable range of the cameras 10a, 10b. For example, when a visual field of the robot 1, that is, the cameras 10a, 10b are oriented upward, the head 8 is oriented upward by the neck pitch-axis motor 22, and concurrently, the camera mount 9 as well is driven by the camera drive motor 25 so as to be oriented upward. There is described hereinafter such a collaborative action as executed by the head 8, and the camera mount 9.

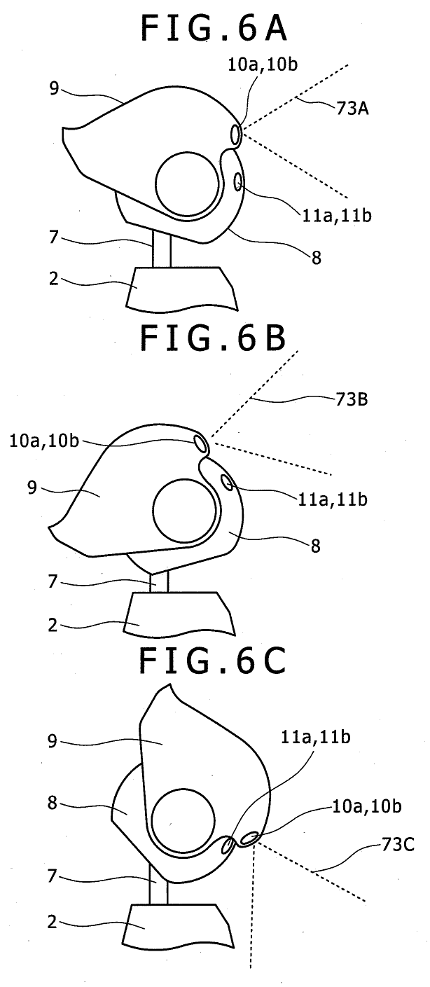

Events, that is, postures taken by the head 8, and the camera mount 9, respectively, can be classified into three outcomes on the basis of the standard posture, the three outcomes including the case of the postures remaining at the position of the standard posture, the case of the postures causing both components to turn upward, and the case of the postures causing both the components to turn downward. Accordingly, combinations of the respective postures taken by the head 8, and the camera mount 9 can be classified into 3 outcomes×3 outcomes=9 outcomes. All the postures according to the 9 outcomes, respectively, can be taken, however, the respective postures according to 3 outcomes, in general use, among the 9 outcomes, are described hereinafter with reference to FIG. 6.

(A) the neck pitch-axis motor: in a standard position, the camera drive motor: in a standard position. FIG. 6A is a side view corresponding to such a posture as above. In this posture, the head 8, and the cameras 10a, 10b are oriented in the horizontal direction. More specifically, the head 8 is erect, and the design on the eyes 11a, 11b is oriented in the horizontal direction. Further, the cameras 10a, 10b mounted in the camera mount 9, as well, are oriented in the horizontal direction. Since the cameras 10a, 10b, in this posture, are positioned at the highest spot of the robot 1, a visual field 73A excellent in visibility in the horizontal direction, as seen from a high position, can be provided by the cameras 10a, 10b. This posture is therefore suitable for use at the time of the robot traveling, and at the time of placing an object on the top of a tall desk.

(B) the neck pitch-axis motor: in a position for causing the head 8 to be oriented upward, the camera drive motor: in the standard position. FIG. 6 (B) is a side view corresponding to such a posture as above. In this posture, the head 8 is turned upward by the rotation of the neck pitch-axis motor 22 to be followed by upward turning of the camera mount 9, along a curve in the front of the head 8. Since the camera drive motor 25 is in the standard position, the cameras 10a, 10b are oriented in the same direction as that for the design on the eyes 11a, 11b.

In this posture, a visual field 73B oriented in an oblique upward direction is gained, so that this posture is suitable for handling an object placed at a position higher than the head of the robot 1. Furthermore, since the cameras 10a, 10b are oriented in the same direction as that for the design on the eyes 11a, 11b, a visual field of the robot coincides with a visual field of the robot, as perceived by the human beings in the surroundings. Accordingly, this posture is suitable for use at the time when the robot has a dialogue with a person taller than a height of the robot.

(C) the neck pitch-axis motor: in a position for causing the head 8 to be oriented downward, the camera drive motor: in a position for causing the cameras 10a, 10b to be oriented downward. FIG. 6C is a side view corresponding to such a posture as above. In this posture, the head 8 is turned downward by the rotation of the neck pitch-axis motor 22. This is followed by downward turning of the camera mount 9, as well, and the camera mount 9 is turned further downward by the rotation of the camera drive motor 25. The cameras 10a, 10b, mounted on the camera mount 9, are caused to slidably move on the outer side of the head 8, as described in the foregoing, without interfering with the head 8.

By combining turning of the head 8, by an action of the neck pitch-axis motor 22, with shifting of the camera mount 9, by an action of the camera drive motor 25, the cameras 10a, 10b can be tilted downward to a large extent, thereby gaining a visual field 73C oriented in a direction directly below. Further, the cameras 10a, 10b are installed such that respective extremities of the cameras 10a, 10b, in the standard position, are substantially flush with the front end of the head 8, in the direction of the back-and-forth motion of the robot. Accordingly, when the cameras 10a, 10b are moved in a downward direction, the respective extremities of the cameras 10a, 10b comes forward ahead of the head 8, as shown in FIG. 6C. Accordingly, it is possible to pick up an image of a portion of the floor surface, immediately ahead the robot, without being blocked by the trunk 2.

Further, because, even in this posture, components of the robot 1, shifting forward, are only the camera mount 9 and the cameras 10a, 10b, a position of the center of gravity of a portion of the robot 1, above the head 8, is not largely shifted, so that the balance of the robot 1 is not significantly affected. Furthermore, since the cameras 10a, 10b are installed such that the respective extremities thereof are substantially flush with the front end of the head 8, in the direction of the back-and-forth motion of the robot, the cameras will not be projected ahead of the head 8in the standard position, so that the cameras will not interfere with traveling/operation of the robot 1.

This posture is therefore suitable for checking a step at the feet of the robot at the time of the robot traveling or at the time of the robot grasping an object at a low position.

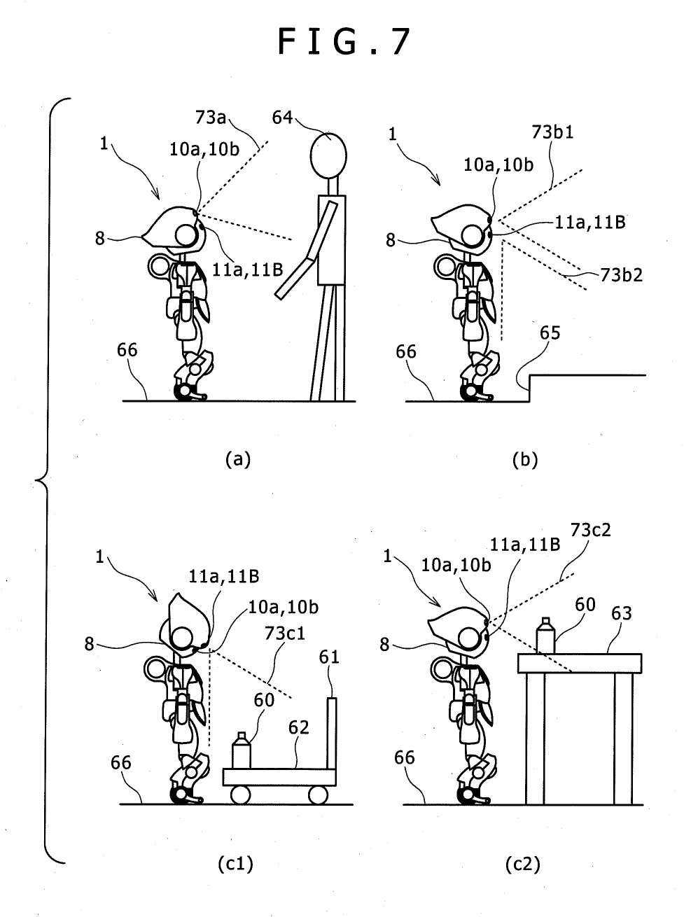

Referring to FIG. 7, there are described hereinafter operations executed by the robot 1 according to the present embodiment, using the drive mechanism for driving the cameras 10a, 10b by way of example. Herein, it is assumed that the robot 1 executes an operation for picking up a target object 60 on a flat car 61 according to an instruction from a person 64, and placing the target object 60 on the top of a desk 63 as indicated.

In the case of this example, a carrier deck 62 of the flat car 61 has a height 150 mm against a height 800 mm of the robot 1, so that the carrier deck 62 is shorter in height than the robot 1. Meanwhile, a desk 63 has a height 600 mm, substantially as tall as the head of the robot 1.

The robot has a basic action comprised of elements including (a) dialogue, (b) traveling, and (c) handling. Herein, the dialogue (a) is an operation for the robot having a dialogue with a human being through speech recognition, speech synthesis, and so forth. The traveling (b) is an operation for causing the robot to travel between different locations by use of a traveling mechanism of the robot. The handling (c) is an operation for causing the robot to grasp, and lift a target object to thereby place the same on a carrier deck, or a desk, the operation being classified into an operation carried out at a low position {low position handling (c1)}, and an operation carried out at a high position {high position handling (c2)}.

An operation whereby the target object 60 placed on the carrier deck 62 of the flat car 61 is placed on the desk 63 as instructed can be executed by four steps as follows:

(1) the step of acquiring an instruction from the person 64 through the dialogue (a);

(2) the step of executing the traveling (b) up to a point in the vicinity of the flat car 61;

(3) the step of grasping the target object 60 on the top of the carrier deck 62 by the low position handling (c1);

(4) the step of executing the traveling (b) up to a point in the vicinity of the desk 63 as instructed; and

(5) the step of placing the target object 60 on the top of the desk 63 by the high position handling (c2).

The basic action for execution of the operations as above is executed by use of the drive mechanism for driving the cameras 10a, 10b, as follows.

(a) The Dialogue

At the time of the dialogue, the robot 1 causes the head 8, and the cameras 10a, 10b to take the posture described in the foregoing (refer to FIG. 7(a)). More specifically, the head 8 is turned upward, and the cameras 10a, 10b are oriented in the same direction as that for the head 8. For smooth person-to-person dialogue, eye contact is important. In the posture described (refer to FIG. 7(a)), the front to the head 8, more specifically, the design on the eyes 11a, 11b is directed toward a human being, so that this posture has an effect giving an impression as if the human being was looking straight in the eyes of the robot while having a dialogue with the robot.

Further, the visual field 73a provided by the cameras 10a, 10b is oriented toward the same direction as the direction of the design on the eyes 11a, 11b, that is, toward the human being, so that it is possible to detect a position of the human being, and to adjust the direction angle of the head 8, to thereby have a dialogue while accurately facing in the direction of the human being. Furthermore, since the microphone 15 is oriented in the direction of the human being, it is possible to clearly capture speech by the human being.

(b) The Traveling

At the time of the robot 1 executing the traveling, the head 8, and the cameras 10a, 10b are caused to take the posture described in the foregoing (refer to FIG. 7(b)). More specifically, the head 8, and the cameras 10a, 10b are oriented in the horizontal direction. By so doing, a visual field 73b1 of the cameras 10a, 10b is oriented forward, so that it is possible to acquire a video in the forward direction to thereby travel while executing detection of the position of the robot 1, and detection of obstacles. Further, in case there exists a step 65 on a floor surface, the robot 1 stops short of the step 65, whereupon the head 8, and the cameras 10a, 10b are caused to take the posture described in the foregoing (refer to FIG. 7(b)). More specifically, the head 8, and the cameras 10a, 10b are oriented in a direction directly below, thereby gaining a visual field 73b2. By so doing, it is possible to pick up an image of the step existing immediately ahead of the robot 1 with the use of the cameras 10a, 10b, whereupon control for safely clearing the step is attained on the basis of information thus obtained.

(c1) the Low Position Handling

In the case of handling an object at a low position such as an object placed on the carrier deck 62 of the flat car 61, the head 8, and the cameras 10a, 10b are caused to take the posture described in the foregoing (refer to FIG. 7(c1)). More specifically, the head 8, and the cameras 10a, 10b are oriented in the direction directly below to thereby gain a visual field 73c1. By so doing, it is possible to pick up an image of a target object 60 placed on the carrier deck 62 at a low position with the use of the cameras 10a, 10b, whereupon a position as well as a shape of the target object 60 can be detected to thereby execute an operation for grasping an object with reliability. Conversely, it is also possible to execute an operation for detecting a layout of objects placed on the top of the carrier deck 62 at the low position to thereby place the target object 60 on the top of the carrier deck 62 with reliability.

(c2) The High Position Handling

In the case of an operation for placing an object at a place close in height to the head of the robot 1, or grasping the object to be lifted down therefrom, the head 8, and the cameras 10a, 10b are caused to take the posture described in the foregoing (refer to FIG. 7(c1)). More specifically, the head 8, and the cameras 10a, 10b are oriented in the horizontal direction to thereby gain a visual field 73c2. In this posture, since the cameras 10a, 10b, are positioned at the highest spot of the robot 1, it is possible to gain excellent visibility in the horizontal direction over a desk, so that a layout of objects placed on the top of the desk 63 can be detected to thereby place the target object 60 on the top of the desk 63 with reliability. Otherwise, the target object 60 on the top of the desk 63 can be grasped with reliability.

Thus, with the robot 1 according to the present embodiment of the invention, since a mechanism for enabling the cameras 10a, 10b to move along the outer periphery of the head 8 is provided, it is possible to move the cameras 10a, 10b beyond a movable range of the head 8, so that images oriented in a wide range from the direction directly below to an upward direction can be inputted without being interfered by the trunk 2 of the robot 1. As a result, the robot 1 is capable of executing operations for traveling, and transporting objects with reliability. In addition to the foregoing, the robot 1 of a structure according to the present embodiment has the following advantages.

The cameras 10a, 10b are used to acquire three-dimensional information including information on a distance up to a human being, or an object, in the surroundings, by stereoscopic-image processing with two units of cameras. The cameras 10a, 10b are installed at the interval substantially equivalent to the full width of the head 8, so that a wide interval can be provided between the cameras 10a, 10b, thereby enabling a distance of an object faraway to be measured with high precision.

At the same time, the cameras 10a, 10b do not come to be projected so as to be off the lateral edges of the head 8, so that the cameras do not interfere with the robot in operation.

Further, since the rotational shaft 45 of the camera drive motor 25 is disposed so as to be substantially coaxial with the rotational shaft 42 of the neck pitch-axis motor 22, if the sum of rotation angles of the camera drive motor 25 is equal to that of the neck pitch-axis motor 22, it is possible to vary a pitch angle of the head 8 with the cameras 10a, 10b kept in the same posture. By so doing, the robot 1 can have a dialogue with the design on the eyes 11a, 11b, oriented toward a human being, while gaining a visual field necessary for traveling and operations.

Since the microphone 15 is mounted in the camera mount 9, it is possible to direct the microphone 15 to a wide range as is the case with the cameras 10a, 10b, so that sound propagating in any of various directions, in a range from a direction directly below to an upward direction, as necessary, can be captured.

Further, since the camera mount 9 is designed so as to look like the cap, eve if the camera mount 9 is moved, this will not impart unseemly feeling to the human beings in the surroundings, but can make a unique impression on them.

With the present embodiment described as above, the cameras 10a, 10b are moved along the outer periphery of the head 8 by turning the camera mount 9 around the rotational shaft 45 of the camera drive motor 25, however, a rail may be provided on the outer periphery of the head 8, and the camera mount 9maybe allowed to travel on the rail instead, thereby enabling the cameras 10a, 10b to move along the outer periphery of the head 8.

Furthermore, in the present description as above, the cameras 10a, 10b each are described as the electronic camera (image pickup device) such as the CCD camera, CMOS camera, and so forth, however, in place of the electronic camera, use may be made of a distance image sensor capable of acquiring distance information on the basis of back-and-forth traveling time of light, together with information on a grayscale image. Otherwise, use may be made of a scanning laser light type distance image sensor for acquiring the information on the grayscale image, and the distance information by scanning with laser light.

Thus, with the robot, a small sized robot, in particular, according to the present embodiment, since the cameras are installed in the camera mount provided over the head, for execution of traveling and operations with reliability, an elevation angle, and a depression angle of each of the cameras can be varied by moving the camera mount independently from an inclination of the head. It is possible to provide a robot having a compact and movable head capable of observing images in a wide range covering a high position to a position immediately ahead the robot, in the direction directly below, as the robot is provided with an image pickup device capable of significantly varying the elevation angle, and the depression angle. Furthermore, according to the present embodiment, it is possible to accomplish a robot giving little unseemly feeling as an anthropomorphic robot.

It should be understood by those skilled in the art that various modifications, combinations, sub-combinations and alterations may occur depending on design requirements and other factors insofar as they are within the scope of the appended claims or the equivalents thereof.

What is claimed is:

1. A robot comprising:
a main body;
a head installed above the main body;
a camera mount installed so as to be movable along a curved surface of an upper part of the head, on a front side thereof; and
cameras mounted in the camera mount.

2. The robot according to claim 1, wherein a horizontal axis is provided inside the head, and the camera mount is supported so as to be swingable around the horizontal axis.

3. The robot according to claim 1, wherein a design on eyes is provided at the front of the head, and the cameras are disposed so as to be positioned above the design on the eyes when the cameras are horizontally oriented.

4. The robot according to claim 1, wherein the cameras are disposed so as to be positioned substantially at the upper end of the robot when the cameras are horizontally oriented.

5. The robot according to claim 1, wherein the cameras are two units of cameras laterally separated from each other at an interval substantially equivalent to a lateral width of the head, and disposed in bilateral symmetry.

6. The robot according to claim 1, wherein the cameras are disposed such that positions of respective extremities thereof, in the direction of a back-and-forth motion of the robot, are substantially flush with the front end of the head.
